(19) United States
(12) Patent Application Publication
(10) Pub. No.: US 2012/0056866 A1
(43) Pub. Date: Mar. 8, 2012

(54) ACTIVE MATRIX ORGANIC LIGHT EMITTING DIODE DISPLAY HAVING RESET FUNCTION

(75) Inventors: Yeun Joong LEE, Seoul (KR); Sang Hyun CHA, Seoul (KR); Gyu Hyeong CHO, Daejeon (KR); Jin Yong JEON, Daegu (KR); Jun Hyeok YANG, Daegu (KR); Hyun Sik KIM, Jeonju (KR); Jae Shin LEE, Anyang (KR)

(73) Assignees: KOREA ADVANCED INSTITUTE OF SCIENCE AND TECHNOLOGY, Daejeon (KR); SAMSUNG ELECTRO-MECHANICS CO., LTD., Gyunggi-do (KR)

(21) Appl. No.: 13/116,472

(22) Filed: May 26, 2011

(30) Foreign Application Priority Data
Sep. 8, 2010 (KR) 10-2010-0087842

(51) Int. Cl. G09G 3/30; G06F 3/038

(52) U.S. Cl. 345/212; 345/76

(57) ABSTRACT

There is provided an active matrix organic light emitting diode (AMOLED) display including a driver generating analog driving signals based on previously prepared driving data; a pixel unit including an organic light emitting diode connected between first and second power supply terminals receiving first and second power, respectively, charging values equivalent to the driving data according to the driving signals and simultaneously detecting the driving signals in order to detect deterioration in a preset tracking period, allowing current to flow through the organic light emitting diode according to the values charged in the tracking period in a preset holding period, and setting a reset period between the holding period and a tracking period subsequent thereto to reset the charged values; and an ADC detecting a deterioration voltage corresponding to the driving signals having deterioration information of the organic light emitting diode of the pixel unit in the tracking period.

### CROSS-REFERENCE TO RELATED APPLICATIONS

This application claims the priority of Korean Patent Application No. 10-2010-0087842 filed on Sep. 8, 2010, in the Korean Intellectual Property Office, the disclosure of which is incorporated herein by reference.

### BACKGROUND OF THE INVENTION

1. Field of the Invention

The present invention relates to an active organic light emitting diode (AMOLED) display having a reset function, and more particularly, to an AMOLED display having a reset function capable of removing a hysteresis effect between data cycles by adding a reset period between the data cycles.

2. Description of the Related Art

In general, in order to manufacture a large-sized display panel using an organic light emitting diode (OLED), prominent as a next generation display device, the OLED display is configured to have an active matrix structure, which is referred to as an active matrix OLED (a so called ‘AMOLED’ display).

Since such an AMOLED display does not need an additional light source, the AMOLED display has remarkable performance in terms of brightness, thickness, definition, speed, power consumption and the like, as compared to an LCD panel using a backlight unit (BLU) as an additional light source.

However, the AMOLED display has disadvantages in that uniformity between pixels and uniformity over time are very low, and a circuit for compensating for uniformity is required.

In general, the driving methods of the AMOLED display are largely divided into a current driving method and a voltage driving method. The voltage driving method of the AMOLED display is disadvantageous in that an output is changed due to deterioration of mobility or threshold voltage of a transistor.

In order to solve the disadvantage of the AMOLED display due to the deterioration of the threshold voltage, a compensating circuit for compensating for the deterioration is required. Further, since the voltage driving method of the AMOLED display needs an additional period in which the degree of deteriorated is detected, excessive time may be required to detect and compensate for the degree of deterioration.

In addition, image data is charged in a capacitor of a pixel unit within a predetermined cycle. Normally, the charged data is completely discharged and then subsequent data is charged. However, due to the properties of hysteresis between the data cycles, the AMOLED display may be inaccurately driven.

### SUMMARY OF THE INVENTION

An aspect of the present invention provides an active matrix organic light emitting diode (AMOLED) display with a reset function capable of removing the effects of hysteresis present between data cycle by adding a reset period between the data cycle.

According to an aspect of the present invention, there is provided an AMOLED display including: a driver generating analog driving signals based on previously prepared driving data; a pixel unit including an organic light emitting diode connected between first and second power supply terminals receiving first and second power, respectively, charging values equivalent to the driving data according to the driving signals and simultaneously detecting the driving signals in order to detect deterioration in a preset tracking period, allowing current to flow through the organic light emitting diode according to the values charged in the tracking period in a preset holding period, and setting a reset period between the holding period and a tracking period subsequent thereto to reset the charged values; and an analog-to-digital (ADC) detecting a deterioration voltage corresponding to the driving signals having deterioration information of the organic light emitting diode of the pixel unit in the tracking period.

The pixel unit may further include first and second MOS transistors connected in series between the first power supply terminal receiving the first power and the organic light emitting diode; a third MOS transistor connected between a first connection node, connected between the first and second MOS transistors, and the driver; a charging capacitor connected between a gate of the second MOS transistor and the first connection node; a fourth MOS transistor having a drain connected to a drain of the second MOS transistor and a source connected to the gate of the second MOS transistor; and a fifth MOS transistor connected between one end of the charging capacitor connected to the gate of the second MOS transistor and the first power supply terminal in order to reset the charging capacitor.

The pixel unit may be configured such that the second, third, and fourth MOS transistors are turned on and the first and fifth MOS transistors are turned off in the tracking period; the first and second MOS transistors are turned on and the third, fourth, and fifth MOS transistors are turned off in the holding period; and the first and fifth MOS transistors are turned on to reset the charging capacitor, and the third and fourth MOS transistors are turned off in the reset period.

The pixel unit may be configured such that: the driving signals of the driver flow to the organic light emitting diode through the second and third MOS transistors to store values equivalent to the driving data in the charging capacitor in the tracking period; the current flows to the organic light emitting diode from the first power supply terminal through the first and second MOS transistors according to the values stored in the charging capacitor in the holding period; and the first power supply terminal is connected to the ends of the charging capacitor through the first and fifth MOS transistors so that a voltage across the charging capacitor becomes 0 in the reset period.

The pixel unit may further include first and second MOS transistors connected in series between the first power supply terminal receiving the first power and the organic light emitting diode; a third MOS transistor connected between a first connection node, connected between the first and second MOS transistors, and the driver; a charging capacitor connected between a gate of the second MOS transistor and the first connection node; a fourth MOS transistor having a drain connected to a drain of the second MOS transistor and a source connected to the gate of the second MOS transistor; a fifth MOS transistor connected between one end of the charging capacitor connected to the gate of the second MOS transistor and the first power supply terminal in order to reset the charging capacitor; and a sixth MOS transistor connected between the other end of the charging capacitor connected to the first connection node and the first power supply terminal.

The pixel unit may be configured such that the second, third, and fourth MOS transistors are turned on and the first, fifth and sixth MOS transistors are turned off in the tracking period; the first and second MOS transistors are turned on and the third, fourth, fifth, and sixth MOS transistors are turned off in the holding period; and the fifth and sixth transistors are turned on to reset the charging capacitor, and the first, third and fourth MOS transistors are turned off in the reset period.

The pixel unit may be configured such that the driving signals of the driver flow to the organic light emitting diode through the second and third MOS transistors to store values equivalent to the driving data in the charging capacitor in the tracking period; the current flows to the organic light emitting diode from the first power supply terminal through the first and second MOS transistors according to the values stored in the charging capacitor in the holding period; and the first power supply terminal is connected to the ends of the charging capacitor through the fifth and sixth MOS transistors so that a voltage across the charging capacitor becomes 0 in the reset period.

The pixel unit may further include first and second MOS transistors connected in series between the first power supply terminal receiving the first power and the organic light emitting diode; a third MOS transistor connected between a first connection node, connected between the first and second MOS transistors, and the driver; a charging capacitor connected between a gate of the second MOS transistor and the first connection node; a fourth MOS transistor having a drain connected to a drain of the second MOS transistor and a source connected to the gate of the second MOS transistor; and a seventh MOS transistor connected to both ends of the charging capacitor in order to reset the charging capacitor.

The pixel unit may be configured such that the second, third, and fourth MOS transistors are turned on and the first and seventh MOS transistors are turned off in the tracking period; the first and second MOS transistors are turned on and the third, fourth, and seventh MOS transistors are turned off in the holding period; and the first and seventh MOS transistors are turned on to reset the charging capacitor, and the third and fourth MOS transistors are turned off in the reset period.

The pixel unit may be configured such that the driving signals of the driver flow to the organic light emitting diode through the second and third MOS transistors to store values equivalent to the driving data in the charging capacitor in the tracking period; the current flows to the organic light emitting diode from the first power supply terminal through the first and second MOS transistors according to the values stored in the charging capacitor in the holding period; and the first power supply terminal is connected to the ends of the charging capacitor through the first and seventh MOS transistors so that a voltage across the charging capacitor becomes 0 in the reset period.

The ADC may detect the deterioration voltage having the deterioration information of the organic light emitting diode in an input node of the pixel unit, to which the driving signals of the driver are inputted, in the tracking period

The AMOLED display may further include a controller generating deterioration compensating signals for compensating for the deterioration using digital deterioration voltage from the ADC, converting input data into driving data, in which deterioration is compensated for, using the deterioration compensating signals, and providing the driving data to the driver.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a circuit block diagram of an active matrix organic light emitting diode (AMOLED) display according to a first exemplary embodiment of the present invention;

FIG. 2 is a diagram explaining operation periods of the AMOLED display according to the first exemplary embodiment of the present invention;

FIG. 3 is a circuit block diagram of an AMOLED display according to a second exemplary embodiment of the present invention;

FIG. 4 is a diagram explaining operation periods of the AMOLED display according to the second exemplary embodiment of the present invention;

FIG. 5 is a circuit block diagram of an AMOLED display according to a third exemplary embodiment of the present invention; and

FIG. 6 is a diagram explaining operation periods of the AMOLED display according to the third exemplary embodiment of the present invention.

### DETAILED DESCRIPTION OF THE PREFERRED EMBODIMENT

Exemplary embodiments of the present invention will now be described in detail with reference to the accompanying drawings.

The present invention should not be construed as being limited to the embodiments set forth herein and the embodiments may be used to assist in understanding the technical idea of the present invention. Like reference numerals designate like components having substantially the same constitution and function in the drawings of the present invention.

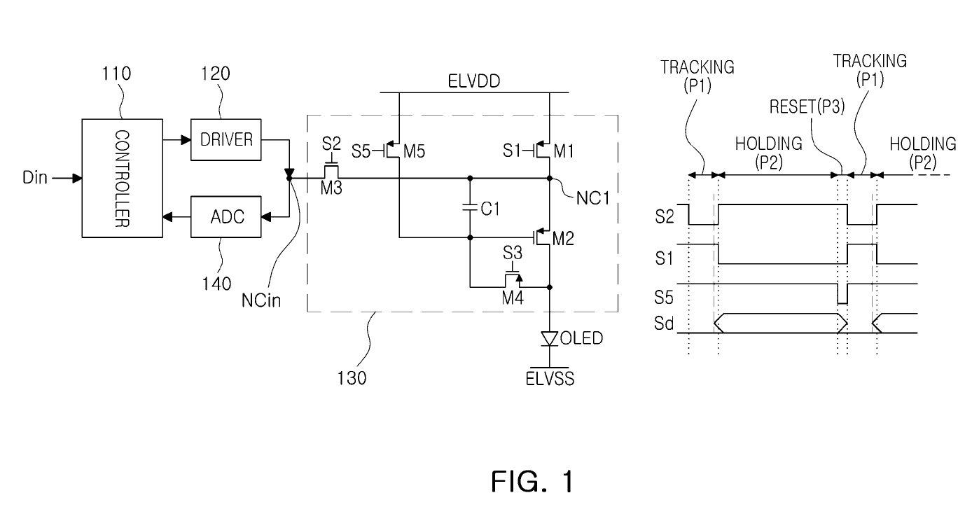

FIG. 1 is a circuit block diagram of an active matrix organic light emitting diode (AMOLED) display according to a first exemplary embodiment of the present invention.

Referring to FIG. 1, an AMOLED display according to a first exemplary embodiment of the present invention may include a driver 120, a pixel unit 130, and an analog-to-digital converter (ADC) 140.

The driver 120 may generate analog driving signals based on previously prepared driving data.

The pixel unit 130 may include an organic light emitting diode (OLED) connected between first and second power supply terminals ELVDD and ELVSS receiving first and second power, respectively. The pixel unit 130 may be configured to charge values equivalent to driving data according to the driving signals and simultaneously detects the driving signals in order to detect deterioration in a preset tracking period; allow current to flow through the OLED according to the values charged in the tracking period in a preset holding period; and set a reset period between the holding period and a tracking period subsequent thereto to reset the charged values.

The ADC 140 may detect deterioration voltage corresponding to the driving signals having deterioration information of the OLED of the pixel unit 130 in the tracking period.

In the first exemplary embodiment of the present invention, the pixel unit 130 may further include first and second MOS transistors M1 and M2 connected in series between the first power supply terminal ELVDD receiving the first power and the OLED, a third MOS transistor M3 connected between a first connection node NC1, connected between the first and second MOS transistors M1 and M2, and the driver 120, a charging capacitor C1 connected between a gate of the second MOS transistor M2 and the first connection node NC1, a fourth MOS transistor M4 having a drain connected to a drain of the second MOS transistor M2 and a source connected to the gate of the second MOS transistor M2, and a fifth MOS transistor M5 connected between one end of the charging capacitor C1 connected to the gate of the second MOS transistor M2 and the first power supply terminal in order to reset the charging capacitor C1.

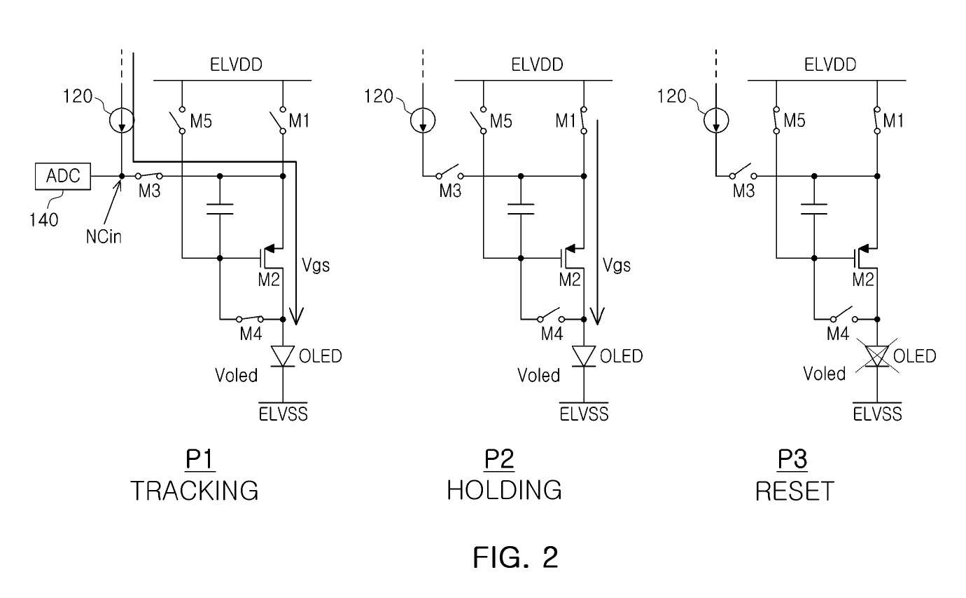

FIG. 2 is a diagram explaining operation periods of the AMOLED display according to the first exemplary embodiment of the present invention.

Referring to FIGS. 1 and 2, the pixel unit 130 may be configured such that the second, third, and fourth MOS transistors M2, M3, and M4 are turned on and the first and fifth MOS transistors M1 and M5 are turned off in the tracking period; the first and second MOS transistors M1 and M2 are turned on and the third, fourth, and fifth MOS transistors M3, M4, and M5 are turned off in the holding period; and the first and fifth MOS transistors M1 and M5 are turned on to reset the charging capacitor C1, and the third and fourth MOS transistors M3 and M4 are turned off in the reset period.

In this case, the pixel unit 130 may be configured such that the driving signal of the driver flows to the OLED through the second and third MOS transistors M2 and M3 to store values equivalent to the driving data in the charging capacitor C1 in the tracking period; the current flows to the OLED from the first power supply terminal through the first and second MOS transistors M1 and M2 according to the values stored in the charging capacitor C1 in the holding period; and the first power supply terminal is connected to both ends of the charging capacitor C1 through the first and fifth MOS transistors M1 and M5 so that the voltage across the charging capacitor C1 may become 0 in the reset period.

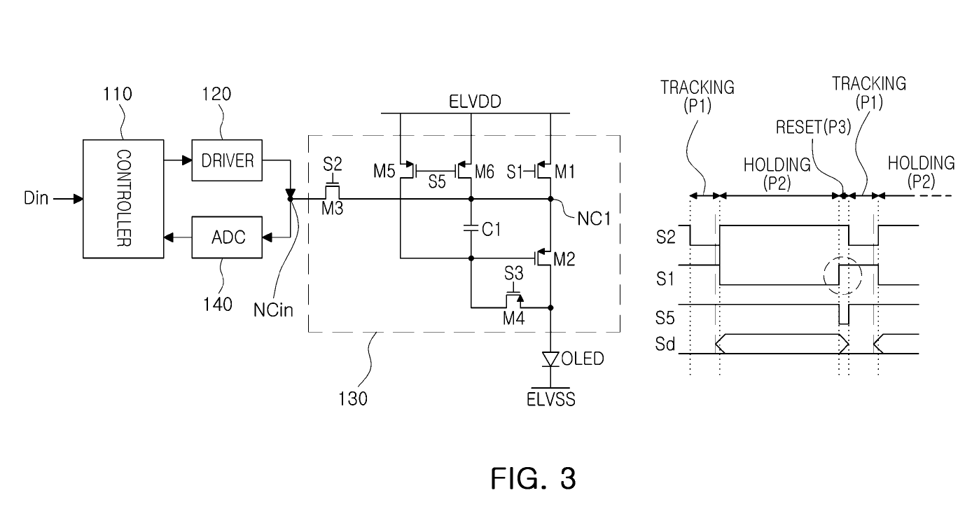

FIG. 3 is a circuit block diagram of an AMOLED display according to a second exemplary embodiment of the present invention.

In the second exemplary embodiment of the present invention, referring to FIG. 3, the pixel unit 130 may further include first and second MOS transistors M1 and M2 connected in series between a first power supply terminal ELVDD receiving a first power and an OLED, a third MOS transistor M3 connected between a first connection node NC1, connected between the first and second MOS transistors M1 and M2, and the driver 120, a charging capacitor C1 connected between a gate of the second MOS transistor M2 and the first connection node NC1, a fourth MOS transistor M4 having a drain connected to a drain of the second MOS transistor M2 and a source connected to a gate of the second MOS transistor M2, a fifth MOS transistor M5 connected between one end of the charging capacitor C1 connected to the gate of the second MOS transistor M2 and the first power supply terminal in order to reset the charging capacitor C1, and a sixth MOS transistor M6 connected between the other end of the charging capacitor C1 connected to the first connection node NC1 and the first power supply terminal.

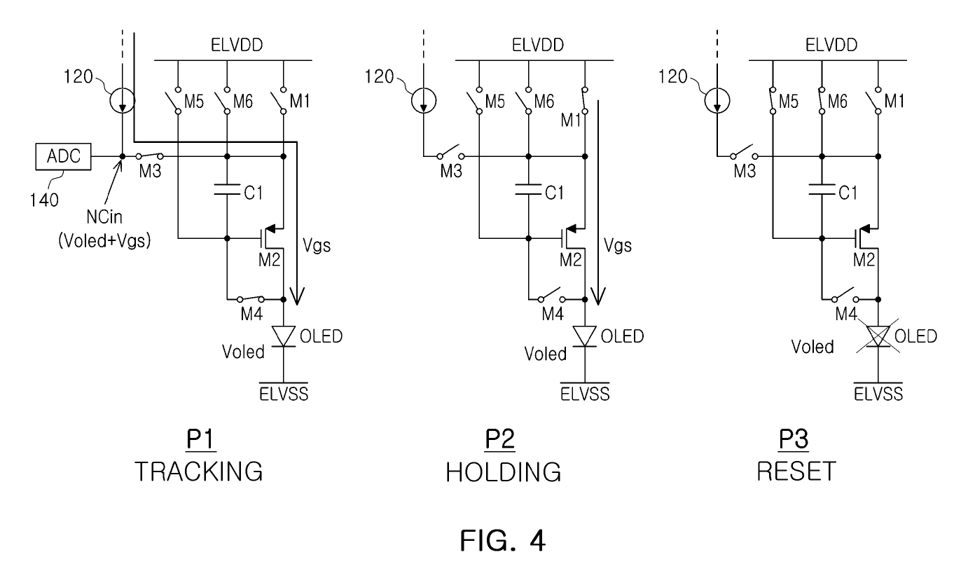

FIG. 4 is a diagram explaining operation periods of the AMOLED display according to the second exemplary embodiment of the present invention.

Referring to FIGS. 3 and 4, the pixel unit 130 may be configured such that the second, third, and fourth MOS transistors M2, M3, and M4 are turned on and the first, fifth, and sixth MOS transistors M1, M5, and M6 are turned off in the tracking period; the first and second MOS transistors M1 and M2 are turned on and the third, fourth, fifth, and sixth MOS transistors M3, M4, M5, and M6 are turned off in the holding period; and the fifth and sixth transistors M5 and M6 are turned on to reset the charging capacitor C1, and the first, third and fourth MOS transistors M1, M3 and M4 are turned off in the reset period.

In this case, the pixel unit 130 may be configured such that the driving signals of the driver flow to the OLED through the second and third MOS transistors M2 and M3 to store values equivalent to the driving data in the charging capacitor C1 in the tracking period; the current flows to the OLED from the first power supply terminal ELVDD through the first and second MOS transistors M1 and M2 according to the values stored in the charging capacitor C1 in the holding period; and the first power supply terminal is connected to both ends of the charging capacitor C1 through the fifth and sixth MOS transistors M5 and M6 so that the voltage across the charging capacitor C1 may become 0 in the reset period.

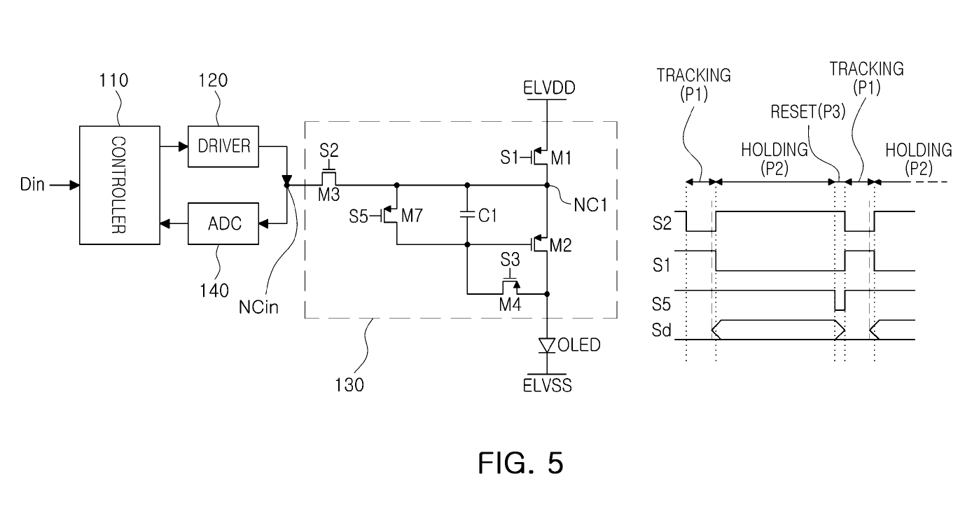

FIG. 5 is a circuit block diagram of an AMOLED display according to a third exemplary embodiment of the present invention.

In the third exemplary embodiment of the present invention, referring to FIG. 5, the pixel unit 130 may further include first and second MOS transistors M1 and M2 connected in series between a first power supply terminal ELVDD receiving a first power and an OLED, a third MOS transistor M3 connected between a first connection node NC1, connected between the first and second MOS transistors M1 and M2, and the driver 120, a charging capacitor C1 connected between a gate of the second MOS transistor M2 and the first connection node NC1, a fourth MOS transistor M4 having a drain connected to a drain of the second MOS transistor M2 and a source connected to a gate of the second MOS transistor M2, and a seventh MOS transistor M7 connected to both ends of the charging capacitor C1 in order to reset the charging capacitor C1.

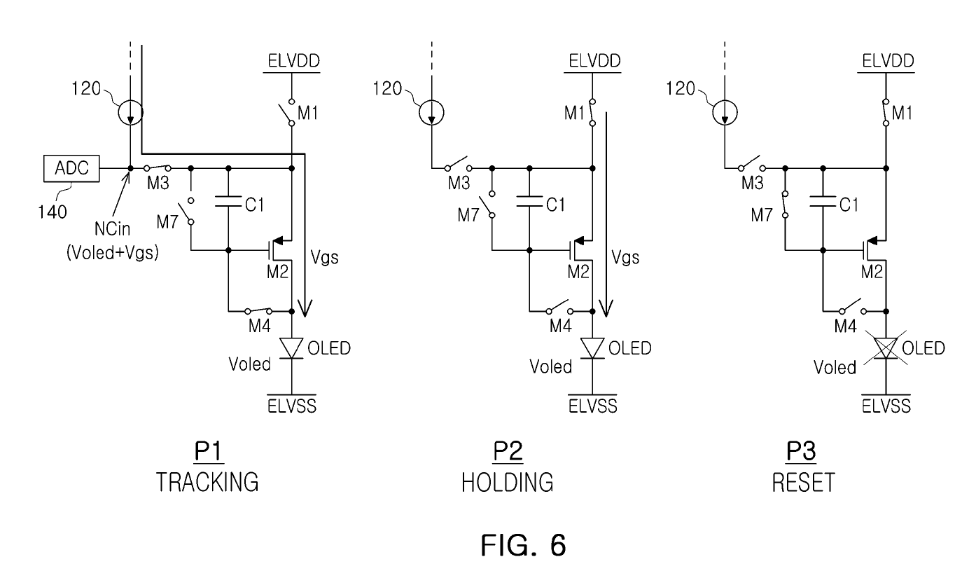

FIG. 6 is a diagram explaining operation periods of the OLED display according to the third exemplary embodiment of the present invention.

Referring to FIGS. 5 and 6, the pixel unit 130 may be configured such that the second, third, and fourth MOS transistors M2, M3, and M4 are turned on and the first and seventh MOS transistors M1 and M7 are turned off in the tracking period; the first and second MOS transistors M1 and M2 are turned on and the third, fourth, and seventh MOS transistors M3, M4, and M7 are turned off in the holding period; and the first and seventh MOS transistors M1 an M7 are turned on to reset the charging capacitor C1, and the third and fourth MOS transistors M3 and M4 are turned off in the reset period.

In this case, the pixel unit 130 may be configured such that the driving signals of the driver flow to the OLED through the second and third MOS transistors M2 and M3 to store values equivalent to the driving data in the charging capacitor C1 in the tracking period; the current flows to the OLED from the first power supply terminal through the first and second MOS transistors M1 and M2 according to the values stored in the charging capacitor C1 in the holding period; and the first power supply terminal is connected to both ends of the charging capacitor C1 through the first and seventh MOS transistors M1 and M7 so that the voltage across the charging capacitor C1 may become 0 in the reset period.

Referring to FIGS. 1, 3 and 5, the ADC may detect deterioration voltage having deterioration information of the OLED in an input node NCin of the pixel unit, to which the driving signals of the driver are inputted, in the tracking period.

In this case, the AMOLED display according to the exemplary embodiments of the present invention may further include a controller 110 generating deterioration compensating signals for compensating for deterioration using digital deterioration voltage from the ADC, converting input data into driving data, in which deterioration is compensated for, using the deterioration compensating signals, providing the driving data to the driver.

Hereinafter, the operations and effects of the present invention will be described in detail with reference to the accompanying drawings.

The operations of the AMOLED display according to the first, second, and third exemplary embodiments of the present invention will be described with reference to FIGS. 1 through 6. The AMOLED display according to each of the exemplary embodiments of the present invention may include the driver 120, the pixel unit 130, and the ADC 140.

The driver 120 may generate analog driving signals based on previously prepared driving data and provide the analog driving signals to the pixel unit 130.

In this case, the pixel unit 130 may charge values equivalent to driving data according to the driving signals and simultaneously detect the driving signals in order to detect deterioration in a preset tracking period; allow current to flow through the OLED according to the values charged in the tracking period in a preset holding period; and set a reset period between the holding period and a tracking period subsequent thereto to reset the charged values.

The ADC 140 may detect deterioration voltage corresponding to the driving signals having deterioration information of the OLED of the pixel unit 130 in the tracking period.

The AMOLED display according to the first exemplary embodiment of the present invention will be first described with reference to FIGS. 1 and 2.

Referring to FIGS. 1 and 2, in the pixel unit 130, the second, third, and fourth MOS transistors M2, M3, and M4 are turned on and the first and fifth MOS transistors M1 and M5 are turned off in the tracking period.

The first and second MOS transistors M1 and M2 are turned on and the third, fourth, and fifth transistors M3, M4, and M5 are turned off in the holding period.

The first and fifth MOS transistors M1 and M5 are turned on to reset the charged capacitor C1 and the third and fourth MOS transistors M3 and M4 are turned off in the reset period.

Herein, the operations of the MOS transistors may be controlled by switching signals S1, S2, S3, S4, and S5 that may be provided from a switching controller (not shown).

According to the operations of the MOS transistors in the pixel unit 130, the driving signals of the driver flow to the OLED through the second and third MOS transistors M2 and M3 to store the values equivalent to the driving data in the charging capacitor C1 in the tracking period P1.

Then, the current flows from the first power supply terminal to the OLED through the first and second MOS transistors M1 and M2 according to the values stored in the charging capacitor C1 in the holding period P2.

Then, the first power supply terminal is connected to both ends of the charging capacitor C1 through the first and fifth MOS transistors M1 and M5 so that the voltage across the charging capacitor C1 may become 0 in the reset period P3. Accordingly, the charging capacitor is reset.

In addition, the ADC 140 detects the deterioration voltage having the deterioration information of the OLED in the input node NCin of the pixel unit, into which the driving signals of the driver are inputted, to provide the deterioration voltage to the controller 110 in the tracking period.

The controller 110 may generate the deterioration compensating signals for compensating for deterioration using the digital deterioration voltage from the ADC 140, convert the input data into the driving data, in which the deterioration is compensated for, using the deterioration compensating signals, and provide the driving data to the driver. The description as described above may also be applied to the second and third exemplary embodiments of the present invention.

The AMOLED display according to the second exemplary embodiment of the present invention will be described with reference to FIGS. 3 and 4.

Referring to FIGS. 3 and 4, in the pixel unit 130, the second, third, and fourth MOS transistors M2, M3, and M4 are turned on and the first, fifth, and sixth MOS transistors M1, M5, and M6 are turned off in the tracking period.

The first and second MOS transistors M1 and M2 are turned on and the third, fourth, fifth, and sixth transistors M3, M4, M5, and M6 are turned off in the holding period.

The fifth and sixth MOS transistors M5 and M6 are turned on to reset the charged capacitor C1 and the first, third and fourth MOS transistors M1, M3 and M4 are turned off in the reset period.

Herein, the operations of the MOS transistors may be controlled by switching signals S1, S2, S3, S4, S5, and S6 that may be provided from a switching controller (not shown).

According to the operations of the MOS transistors in the pixel unit 130, the driving signals of the driver flow to the OLED through the second and third MOS transistors M2 and M3 to store the values equivalent to the driving data in the charging capacitor C1 in the tracking period.

The current flows from the first power supply terminal ELVDD to the OLED through the first and second MOS transistors M1 and M2 according to the values stored in the charging capacitor C1 in the holding period.

Then, the first power supply terminal is connected to both ends of the charging capacitor C1 through the fifth and sixth MOS transistors M5 and M6 so that the voltage across the charging capacitor C1 may become 0 in the reset period. Accordingly, the charging capacitor is reset.

The AMOLED display according to the third exemplary embodiment of the present invention will be described with reference to FIGS. 5 and 6.

Referring to FIGS. 5 and 6, in the pixel unit 130, the second, third, and fourth MOS transistors M2, M3, and M4 are turned on and the first and seventh MOS transistors M1 and M7 are turned off in the tracking period.

The first and second MOS transistors M1 and M2 are turned on and the third, fourth, and seventh transistors M3, M4, and M7 are turned off in the holding period.

The first and seventh MOS transistors M1 and M7 are turned on to reset the charged capacitor C1 and the third and fourth MOS transistors M3 and M4 are turned off in the reset period.

Herein, the operations of the MOS transistors may be controlled by switching signals S1, S2, S3, S4, and S7 that may be provided from a switching controller (not shown).

According to the operations of the MOS transistors in the pixel unit 130, the driving signals of the driver flow to the OLED through the second and third MOS transistors M2 and M3 to store the values equivalent to the driving data in the charging capacitor C1 in the tracking period.

Then, the current flows from the first power supply terminal to the OLED through the first and second MOS transistors M1 and M2 according to the values stored in the charging capacitor C1 in the holding period.

Then, the first power supply terminal is connected to both ends of the charging capacitor C1 through the first and seventh MOS transistors M1 and M7 so that the voltage across the charging capacitor C1 may become 0 in the reset period.

According to the exemplary embodiments of the present invention as described above, the programming operation and the deterioration detecting operation are simultaneously performed in the tracking period P1 and the reset period P3 is set subsequent to the holding period P2, such that a hysteresis effect generated between the data cycles can be removed.

As set forth above, according to exemplary embodiments of the present invention, a reset period is added between data cycles, which allows for a reset function capable of removing a hysteresis effect between the data cycles.

In addition, since a real time image display and compensation therefor are simultaneously performed, the compensation can be performed by using a single ADC. Accordingly, the area of the driver can be significantly reduced.

While the present invention has been shown and described in connection with the exemplary embodiments, it will be apparent to those skilled in the art that modifications and variations can be made without departing from the spirit and scope of the invention as defined by the appended claims.

What is claimed is:

1. An active matrix organic light emitting diode (AMOLED) display comprising:
a driver generating analog driving signals based on previously prepared driving data;
a pixel unit including an organic light emitting diode connected between first and second power supply terminals receiving first and second power, respectively, charging values equivalent to the driving data according to the driving signals and simultaneously detecting the driving signals in order to detect deterioration in a preset tracking period, allowing current to flow through the organic light emitting diode according to the values charged in the tracking period in a preset holding period, and setting a reset period between the holding period and a tracking period subsequent thereto to reset the charged values; and
an analog-to-digital converter (ADC) detecting a deterioration voltage corresponding to the driving signals having deterioration information of the organic light emitting diode of the pixel unit in the tracking period.

2. The AMOLED display of claim 1, wherein the pixel unit further comprises:
first and second MOS transistors connected in series between the first power supply terminal receiving the first power and the organic light emitting diode;
a third MOS transistor connected between a first connection node, connected between the first and second MOS transistors, and the driver;
a charging capacitor connected between a gate of the second MOS transistor and the first connection node;
a fourth MOS transistor having a drain connected to a drain of the second MOS transistor and a source connected to the gate of the second MOS transistor; and
a fifth MOS transistor connected between one end of the charging capacitor connected to the gate of the second MOS transistor and the first power supply terminal in order to reset the charging capacitor.

3. The AMOLED display of claim 2, wherein the pixel unit is configured such that:
the second, third, and fourth MOS transistors are turned on and the first and fifth MOS transistors are turned off in the tracking period;
the first and second MOS transistors are turned on and the third, fourth, and fifth MOS transistors are turned off in the holding period; and
the first and fifth MOS transistors are turned on to reset the charging capacitor, and the third and fourth MOS transistors are turned off in the reset period.

4. The AMOLED display of claim 3, wherein the pixel unit is configured such that:
the driving signals of the driver flow to the organic light emitting diode through the second and third MOS transistors to store values equivalent to the driving data in the charging capacitor in the tracking period;
the current flows to the organic light emitting diode from the first power supply terminal through the first and second MOS transistors according to the values stored in the charging capacitor in the holding period; and
the first power supply terminal is connected to the ends of the charging capacitor through the first and fifth MOS transistors so that a voltage across the charging capacitor becomes 0 in the reset period.

5. The AMOLED display of claim 1, wherein the pixel unit further comprises:
first and second MOS transistors connected in series between the first power supply terminal receiving the first power and the organic light emitting diode;
a third MOS transistor connected between a first connection node, connected between the first and second MOS transistors, and the driver;
a charging capacitor connected between a gate of the second MOS transistor and the first connection node;
a fourth MOS transistor having a drain connected to a drain of the second MOS transistor and a source connected to the gate of the second MOS transistor;
a fifth MOS transistor connected between one end of the charging capacitor connected to the gate of the second MOS transistor and the first power supply terminal in order to reset the charging capacitor; and
a sixth MOS transistor connected between the other end of the charging capacitor connected to the first connection node and the first power supply terminal.

6. The AMOLED display of claim 5, wherein the pixel unit is configured such that:
the second, third, and fourth MOS transistors are turned on and the first, fifth, and sixth MOS transistors are turned off in the tracking period;
the first and second MOS transistors are turned on and the third, fourth, fifth, and sixth MOS transistors are turned off in the holding period; and
the fifth and sixth transistors are turned on to reset the charging capacitor, and the first, third and fourth MOS transistors are turned off in the reset period.

7. The AMOLED display of claim 6, wherein the pixel unit is configured such that:
the driving signals of the driver flow to the organic light emitting diode through the second and third MOS transistors to store values equivalent to the driving data in the charging capacitor in the tracking period;
the current flows to the organic light emitting diode from the first power supply terminal through the first and second MOS transistors according to the values stored in the charging capacitor in the holding period; and
the first power supply terminal is connected to the ends of the charging capacitor through the fifth and sixth MOS transistors so that a voltage across the charging capacitor becomes 0 in the reset period.

8. The AMOLED display of claim 1, wherein the pixel unit further comprises:
first and second MOS transistors connected in series between the first power supply terminal receiving the first power and the organic light emitting diode;
a third MOS transistor connected between a first connection node, connected between the first and second MOS transistors, and the driver;
a charging capacitor connected between a gate of the second MOS transistor and the first connection node;
a fourth MOS transistor having a drain connected to a drain of the second MOS transistor and a source connected to the gate of the second MOS transistor; and
a seventh MOS transistor connected to both ends of the charging capacitor in order to reset the charging capacitor.

9. The AMOLED display of claim 8, wherein the pixel unit is configured such that:
the second, third, and fourth MOS transistors are turned on and the first and seventh MOS transistors are turned off in the tracking period;
the first and second MOS transistors are turned on and the third, fourth, and seventh MOS transistors are turned off in the holding period; and
the first and seventh MOS transistors are turned on to reset the charging capacitor, and the third and fourth MOS transistors are turned off in the reset period.

10. The AMOLED display of claim 9, wherein the pixel unit is configured such that:
the driving signals of the driver flow to the organic light emitting diode through the second and third MOS transistors to store values equivalent to the driving data in the charging capacitor in the tracking period;
the current flows to the organic light emitting diode from the first power supply terminal through the first and second MOS transistors according to the values stored in the charging capacitor in the holding period; and
the first power supply terminal is connected to the ends of the charging capacitor through the first and seventh MOS transistors so that a voltage across the charging capacitor becomes 0 in the reset period.

11. The AMOLED display of claim 1, wherein the ADC detects the deterioration voltage having the deterioration information of the organic light emitting diode in an input node of the pixel unit, to which the driving signals of the driver are inputted, in the tracking period.

12. The AMOLED display of claim 11, further comprising a controller generating deterioration compensating signals for compensating for the deterioration using digital deterioration voltage from the ADC, converting input data into driving data, in which deterioration is compensated for, using the deterioration compensating signals, and providing the driving data to the driver.
